(19) United States
(12) Patent Application Publication
(10) Pub. No.: US 2025/0264356 A1
(43) Pub. Date: Aug. 21, 2025

(54) PORTABLE WEIGHING SYSTEM

(71) Applicant: AlixPartners, LLP, Southfield, MI (US)

(72) Inventors: Abhinav AGRAWAL, Dallas, TX (US); Robert George STERNER, Miami, FL (US); Ricardo REYES, CABA Buenos Aires (AR); Qianbo WANG, New York City, NY (US)

(21) Appl. No.: 18/859,309

(22) PCT Filed: May 18, 2023
(86) PCT No.: PCT/US2023/022654

§ 371 Date: Oct. 23, 2024

Related U.S. Application Data
(60) Provisional application No. 63/354,002, filed on Jun. 21, 2022.

(51) Int. Cl. G01G 23/37; G01D 21/02; G01G 21/28

(52) U.S. Cl. CPC G01G 23/3742; G01D 21/02; G01G 21/283

(57) ABSTRACT

A portable weighing system includes: a portable table; a battery disposed on the portable table and that includes an external charge port configured to receive power for charging the battery; a scale that is disposed on the portable table, that receives power from the battery by wire, and that measures weights of objects, respectively, placed on the scale; a user interface module disposed on the portable table and configured to receive the measured weights of the objects, respectively, from the scale by wire from the scale; and a cellular hotspot module disposed on the portable table and configured to: receive the measured weights of the objects, respectively, wirelessly from the user interface module; and transmit the measured weights of the objects, respectively, via a cellular network.

### CROSS-REFERENCE TO RELATED APPLICATIONS

This application claims the benefit of U.S. Provisional Application No. 63/354,002 filed on Jun. 21, 2022. The entire disclosure of the above application is incorporated herein by reference.

### FIELD

The present disclosure relates to systems and methods for weighing objects in manufacturing facilities and more particularly to portable and battery powered systems and methods for weighing objects.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Scales are available in a variety of different forms. For example, home and medical scales are available to weigh humans. Kitchen scales can be used in home and commercial kitchens to weigh various types of food items. Such scales may include one or more internal batteries or be plugged into a standard wall outlet for power.

Proper weighing of packaged objects is necessary to ensure that the objects are not over or under weight. Objects sold packaged as X weight while actually weighing less than X may expose the maker or seller of the objects to litigation. Objects sold packaged as X weight while actually weighing more than X cost the maker of the objects in lost material.

### SUMMARY

In a feature, a portable weighing system includes: a portable table; a battery disposed on the portable table and that includes an external charge port configured to receive power for charging the battery; a scale that is disposed on the portable table, that receives power from the battery by wire, and that measures weights of objects, respectively, placed on the scale; a user interface module disposed on the portable table and configured to receive the measured weights of the objects, respectively, from the scale by wire from the scale; and a cellular hotspot module disposed on the portable table and configured to: receive the measured weights of the objects, respectively, wirelessly from the user interface module; and transmit the measured weights of the objects, respectively, via a cellular network.

In further features, a temperature sensor is disposed on the portable table and configured to measure a temperature of air, where: the user interface module is further configured to receive the temperature; and the cellular hotspot module is further configured to transmit the temperature via the cellular network.

In further features, a humidity sensor is disposed on the portable table and configured to measure a humidity of air, where: the user interface module is further configured to receive the humidity; and the cellular hotspot module is further configured to transmit the humidity via the cellular network.

In further features, a viscosity sensor is configured to measure viscosities of the objects, respectively, where: the user interface module is further configured to receive the viscosities; and the cellular hotspot module is further configured to transmit the viscosities via the cellular network.

In further features, the scale is one of a food grade scale and an industrial grade scale.

In further features, the user interface module has an ingress protection (IP) rating for dust and water of the IP66 rating or higher.

In further features, the user interface module includes a touchscreen display.

In further features, the user interface module includes a Raspberry Pi circuit board.

In further features, the user interface module is configured to wirelessly transmit the measured weights of the objects, respectively, to the cellular hotspot module using the message queuing telemetry transport (MQTT) communication protocol.

In further features, the portable table includes at least three wheels.

In a feature, a system includes: the portable weighing system; and a control module configured to receive the measured weights of the objects, respectively, from the cellular hotspot module via the cellular network.

In further features, the control module is configured to selectively output at least one of a visual alert and an audible alert based on at least one of the measured weights of the objects, respectively.

In further features, the control module is configured to output the at least one of the visual alert and the audible alert when the at least one of the measured weights is one of: greater than a predetermined weight by at least a predetermined amount; and less than the predetermined weight by at least the predetermined amount.

In further features, the control module is further configured to output the measured weights of the objects, respectively, to a computing device via a network.

In further features, the computing device is configured to display the measured weights of the objects, respectively, on a display.

In a feature, a portable weighing method includes: by a battery disposed on a portable table and including an external charge port configured to receive power for charging the battery, outputting power; by a scale that is disposed on the portable table, receiving power from the battery by wire, and measuring weights of objects, respectively, placed on the scale; by a user interface module disposed on the portable table, receiving the measured weights of the objects, respectively, from the scale by wire from the scale; and by a cellular hotspot module disposed on the portable table: receiving the measured weights of the objects, respectively, wirelessly from the user interface module; and transmitting the measured weights of the objects, respectively, via a cellular network.

In further features, the portable weighing method further includes: by a temperature sensor disposed on the portable table, measuring a temperature of air; by the user interface module, receiving the temperature; and by the cellular hotspot module, transmitting the temperature via the cellular network.

In further features, the portable weighing method further includes: by a humidity

sensor disposed on the portable table, measuring a humidity of air; by the user interface module, receiving the humidity; and by the cellular hotspot module, transmitting the humidity via the cellular network.

In further features, the portable weighing method further includes: by a viscosity sensor, measuring viscosities of the objects, respectively; by the user interface module, receiving the viscosities; and by the cellular hotspot module, transmitting the viscosities via the cellular network.

In further features, the scale is one of a food grade scale and an industrial grade scale.

In further features, the user interface module has an ingress protection (IP) rating for dust and water of the IP66 rating or higher.

In further features, the user interface module includes a touchscreen display.

In further features, the user interface module includes a Raspberry Pi circuit board.

In further features, the portable weighing method further includes, by the user interface module, wirelessly transmitting the measured weights of the objects, respectively, to the cellular hotspot module using the message queuing telemetry transport (MQTT) communication protocol.

In further features, the portable table includes at least three wheels.

In further features, the portable weighing method further includes: by a control module, receiving the measured weights of the objects, respectively, from the cellular hotspot module via the cellular network.

In further features, the portable weighing method further includes, by the control module, selectively outputting at least one of a visual alert and an audible alert based on at least one of the measured weights of the objects, respectively.

In further features, the portable weighing method further includes, by the control module, outputting the at least one of the visual alert and the audible alert when the at least one of the measured weights is one of: greater than a predetermined weight by at least a predetermined amount; and less than the predetermined weight by at least the predetermined amount.

In further features, the portable weighing method further includes, by the control module, outputting the measured weights of the objects, respectively, to a computing device via a network.

In further features, the portable weighing method further includes, by the computing device, displaying the measured weights of the objects, respectively, on a display.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is an example diagram of an example portable weighing system;

FIG. 2 is a functional block diagram of an example measurement and control system;

FIG. 3 is a flowchart depicting an example method of collecting and using measurements from the portable weighing system; and

FIG. 4 is a functional block diagram of an example data analysis system.

In the drawings, reference numbers may be reused to identify similar and/or identical elements.

### DETAILED DESCRIPTION

Over and underweight (relative to a target weight) products cost makers of the products money. For example, a maker of baked goods may target raw dough portions to be X ounces each. If the raw dough portions are X+1 ounces, a profit margin of the maker decreases due to the raw dough portions being overweight. In a high volume environment, the loss attributable to the over weighting may be exacerbated.

The present application involves a portable weighing system that can be used to measure weights of objects, such as raw dough portions. A scale receives power from a battery on a portable table as to not need to be connected to a standard wall outlet. The measurements are transmitted to a remote location via a cellular network. This eliminates the need for a wired or wireless connection to a network of a building, which might require credentials for security. The portable weighing system therefore enables weights to be captured and communicated for analysis quickly and without the need for connection to power or a communication network at the place (e.g., building) where the measuring is occurring.

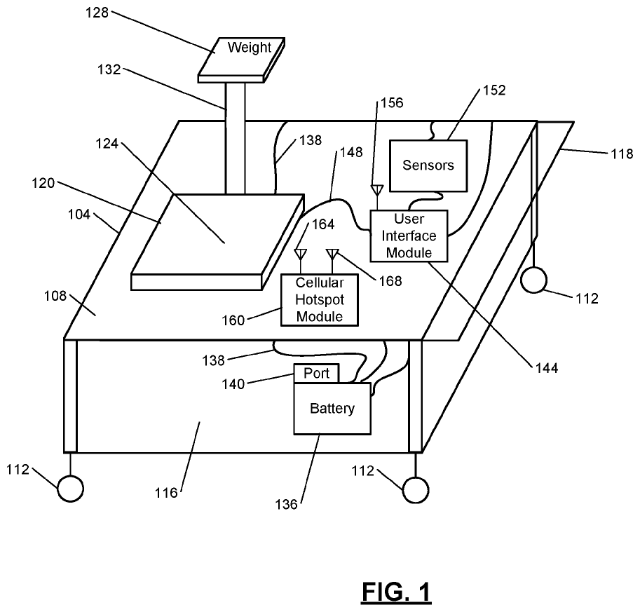

FIG. 1 is a diagram of an example portable weighing system. A table 104 includes a top surface 108 and wheels 112. The wheels 112 may include locks configured to prevent the wheels 112, respectively, from rotating. The table 104 may include 3 wheels, 4 wheels, or another suitable number of wheels. Also, while the example of wheels is provided, the present application is also applicable to other types of devices that allow the table 104 to move, such as tracks. In various implementations, one or more of the wheels may be driven by one or more electric motors to move the table 104. In various implementations, the table 104 may include one or more shelves, such as shelf 116, disposed vertically below the top surface 108. The table 104 may also include one or more handles, such as handle 118. The table 104 may also include one or more height adjustment mechanisms configured to adjust a height of the top surface 108.

A scale 120 is provided on the table 104. The scale may be an industrial scale in various implementations and a weighing surface 124 of the scale 120 may be food safe (e.g., made of a stainless steel). The scale 120 may be a food grade scale, an industrial grade scale, or have another suitable grade.

Items to be weighed are placed on the weighing surface 124 to be weighed. The scale 120 includes a weight display 128 that displays the weight of one or more objects that are upon the weighing surface 124. The weight display 128 may be configured to display the weight in English units (e.g., ounces, pounds, etc.) or metric units (e.g., grams, milligrams, kilograms, etc.) based on user input to the scale 120. A riser 132 may hold the weight display 128 a predetermined distance above the weighing surface 124, for example, for ergonomics so a user of the scale need not look too far downward. The scale 120 may include one or more user inputs (e.g., buttons, switches, etc.) that can be used to change whether to display the weight in English units or metric units, to calibrate (zero) the scale 120, and to perform one or more other functions.

The scale 120 receives power from a battery 136 that sits on the top surface 108 or a shelf of the table 104. The scale 120 receives power from the battery 136 by wire 138. The battery 136 may have a 12 volt direct current (DC) output or another suitable output voltage. The battery 136 has a capacity sufficient for the scale 120 to be on continuously for at least a predetermined period, such as 8 hours, 10 hours, 12 hours, 16 hours, 24 hours, or another suitable period. This may allow the table 104 and the scale 120 to be used continuously for at least a shift of a worker. The battery 136 includes an external charge port 140 via which the battery 136 can be charged. The external charge port 140 may receive power, for example, via a charge cable connected to a wall outlet (e.g., a 120 volt alternating current (AC)) wall outlet, via a docking/charging station, a DC power supply, or in another suitable manner.

The scale 120 outputs measurements to a user interface module 144 by wire 148. The scale 120 may include a serial port and communicate with the user interface module 144 using a serial communication protocol such as a recommended standard (RS) 232 protocol. In various implementations, the scale 120 may communicate with the user interface module 144 in another suitable manner by wire or wirelessly.

The user interface module 144 includes a display, such as a touchscreen display. User input may be input to the user interface module 144 via the touchscreen display and/or one or more other input devices, such as one or more buttons, switches, etc. Examples of user input include an operator of the scale 120, a shift indicator (e.g., first, second, third), a date, an identifier of a product being weighed, etc. The user interface module 144 may include a Raspberry Pi circuit board, such as the Raspberry Pi Zero circuit board (e.g., W, 2 W, etc.), the Raspberry Pi Zero 2 W circuit board, a Raspberry Pi 3 Model circuit board (A, A+, B, B+, etc.), a Raspberry Pi 1 Model circuit board (A, A+, B, B+, etc.).

The user interface module 144 may have at least a predetermined minimum ingress protection (IP) rating for dust and water, such as at least the IP66 rating (6 for dust, 6 for water). This may ensure that the user interface module 144 can be used despite dusty and/or wet conditions. The battery 136 may also have at least the predetermined minimum ingress protection rating. The weight display 128 may also have at least the predetermined minimum ingress protection rating. In various implementations, covers (e.g., plastic) may be provided over at least one of the user interface module 144, the battery 136, and the weight display 128.

Sensors 152 measure one or more parameters and communicate the measurements to the user interface module 144 by wire or wirelessly. Wireless communication may be, for example, WiFi communication (e.g., according to an IEEE 802.11 standard), Bluetooth communication (e.g., according to an IEEE 802.15 standard), Zigbee communication (e.g., according to the 802.15 standard), or another suitable type of wireless communication. The user interface module 144 includes one or more antennas, such as antenna 156, for wireless communication (transmission and/or reception). Examples of the sensors 152 include a temperature sensor configured to measure a temperature of air at the location of the scale 120 and a humidity sensor configured to measure a humidity (e.g., relative) of air at the location of the scale 120. The sensors 152 may also include one or more other types of sensors, such as a viscosity sensor configured to measure a viscosity of the product being weighed on the scale 120.

The sensors 152 may be powered by an internal rechargeable battery or may receive power from the battery 136 by wire. The user interface module 144 may be powered by an internal rechargeable battery or may receive power from the battery 136 by wire.

A cellular hotspot module 160 receives the measurements (e.g., weight, temperature, humidity, viscosity) and other data (e.g., present time and date, the operator of the scale 120, the shift indicator (e.g., first, second, third), the identifier of the product being weighed, etc.) wirelessly from the user interface module 144. Wireless communication between the user interface module 144 and the cellular hotspot module 160 may be for example, WiFi communication (e.g., according to an IEEE 802.11 standard), Bluetooth communication (e.g., according to an IEEE 802.15 standard), Zigbee communication (e.g., according to the 802.15 standard), MQTT (message queuing telemetry transport) communication, or another suitable type of wireless communication. The cellular hotspot module 160 includes one or more antennas, such as antenna 164, for wireless communication (transmission and/or reception) with the user interface module 144.

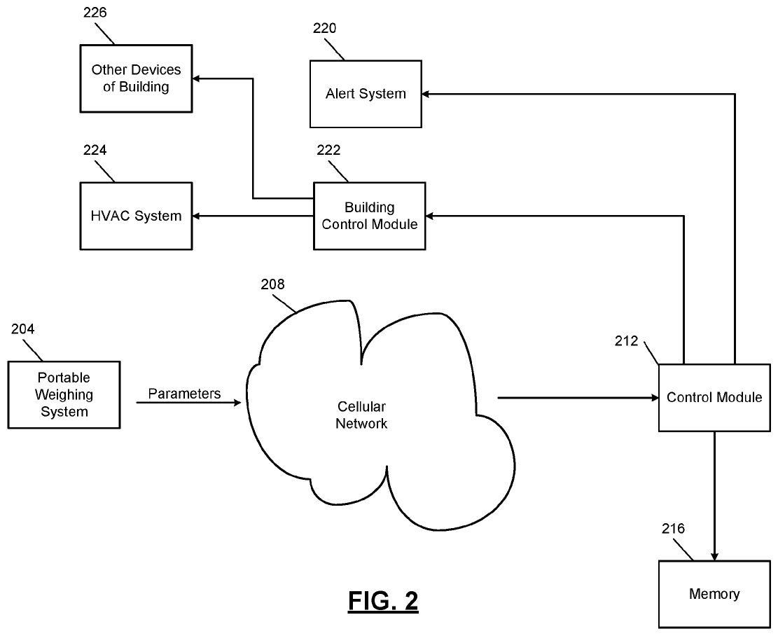

The cellular hotspot module 160 wirelessly transmits the measurements and the other data to a control module (see FIG. 2) via a cellular network, such as the 3G cellular network, the 4G cellular network, the LTE cellular network, the 5G cellular network or another suitable cellular network. The cellular hotspot module 160 may be powered by an internal rechargeable battery or may receive power from the battery 136 by wire.

The table 104 being portable and moveable allows the scale 120 to be moved to various different locations, such as throughout a building. The battery 136 powering the scale 120 allows the scale 120 to be used continuously for a long period of time without the need for the scale 120 to be plugged into a wall outlet and eliminates the possible hazard of the presence of a wire connecting the scale 120 to a wall outlet. The devices having at least the predetermined minimum ingress protection rating enables use in places with high levels of dust, such as buildings where flour is used in baked goods. The user interface module 144 is programable and customizable and includes a large touchscreen display for easy viewing and use by an operator. Temperature and humidity being measured may allow for changes to be made to adjust air temperature and/or humidity within the building.

The cellular hotspot module 160 allows the measurements and other parameters to be transmitted to the control module without the need for a wired connection (e.g., an ethernet connection) to a network of the building or a wireless connection (e.g., a WiFi connection) to the network of the building. The portable weighing system can therefore simply be rolled into a building and used to transmit the measurements other parameters to be transmitted to the control module without the need for a connection to a wired or wireless network of the building. Instead, the measurements and other parameters are communicated via a cellular network, as discussed above.

FIG. 2 is a functional block diagram of an example measurement and control system. The portable weighing system of FIG. 1 is illustrated by 204. As discussed above, the cellular hotspot module 160 transmits the measurements and other parameters (collectively illustrated as parameters) via a cellular network 208 to a control module 212. The control module 212 may store the measurements and other parameters in memory 216, such as in a database. For example, the measurements and other parameters may be stored in association with the time and date when a weight measurement was taken. The control module 212 may be located at the building or remote from the building.

The control module 212 may selectively take one or more actions based on one or more of the measurements. For example, the control module 212 may output an alert via an alert system 220 when one or more of the weights of objects, respectively, are greater than or less than a target weight by more than a predetermined tolerance. The predetermined tolerance may be, for example, 1% of the target weight, a predetermined weight (e.g., 0.5 ounces), or another suitable value. The alert may include, for example, at least one of an audible alert from a speaker and a visual alert via an output device, such as an indicator or a display. The alert system 220 may include at least one of (a) one or more speakers (e.g., to output an audible alert) and (b) one or more visual output devices (e.g., indicators, displays, etc.). The alert may prompt one or more changes to be made to increase (e.g., when the weight is less than the target weight) or decrease (e.g., when the weight is greater than the target weight) the weights of the products. In various implementations, the control module 212 may adjust one or more parameters of one or more machines that output the product. For example, the control module 212 may actuate a cutter of a machine earlier to decrease the weights of the objects or later to increase the weights of the objects.

Additionally or alternatively, the control module 212 may output an alert via the alert system 220 when one or more of the temperatures within the building are greater than a first predetermined temperature or less than a second predetermined temperature. The second predetermined temperature may be less than the first predetermined temperature. In various implementations, the control module 212 may, via a building control module 222 of the building, turn on and operate a heating ventilation and air conditioning (HVAC) system 224 of the building when one or more of the temperatures within the building are greater than the first predetermined temperature or less than the second predetermined temperature. For example, the control module 212 may turn on heating by the HVAC system 224 when the one or more temperatures are less than the second predetermined temperature. The control module 212 may turn on cooling by the HVAC system 224 when the one or more temperatures are greater than the first predetermined temperature.

Additionally or alternatively, the control module 212 may output an alert via the alert system 220 when one or more of the humidities within the building are greater than a first predetermined humidity or less than a second predetermined humidity. The second predetermined humidity may be less than the first predetermined humidity. In various implementations, the control module 212 may turn on and operate the HVAC system 224 of the building when one or more of the humidity within the building are greater than the first predetermined humidity or less than the second predetermined humidity. For example, the control module 212 may turn on a humidifier of the HVAC system 224 when the one or more humidities are less than the second predetermined humidity. The control module 212 may turn on dehumidification by the HVAC system 224 (e.g., via cooling or heating without humidification) when the one or more humidities are greater than the first predetermined humidity. Some products (e.g., baked goods) may be more sensitive to air temperature and/or humidity.

Additionally or alternatively, the control module 212 may, via the building control module 222, turn on, turn off, or control one or more other devices within the building 226 based on the temperature within the building and/or the humidity within the building.

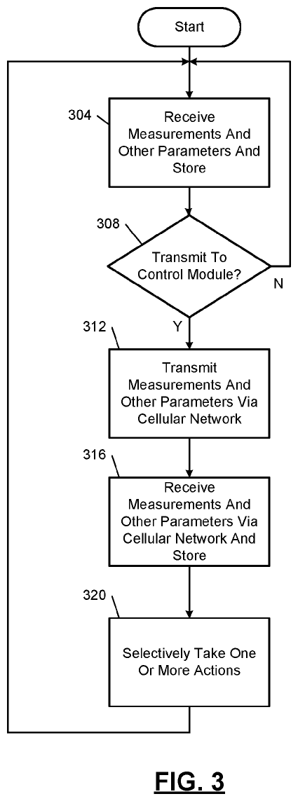

FIG. 3 is a flowchart depicting an example method of collecting and using measurements from the portable weighing system. At 304, the user interface module 144 receives the measurements from the scale 120 and the sensors 152. The user interface module 144 stores the measurements and the other parameters in memory of the user interface module 144. The user interface module 144 may capture and store the measurements from the sensors 152 and the other parameters each time a measurement is taken via the scale 120.

At 308, the user interface module 144 or the cellular hotspot module 160 determines whether to transmit the stored measurements and other parameters to the control module 212. For example, the user interface module 144 may transmit the stored data every predetermined period (e.g., 15 minutes, 30 minutes, 1 hour, etc.), every time a predetermined number of measurements from the scale 120 are captured (e.g., 20, 50, etc.), or at another suitable frequency. In various implementations, the user interface module 144 may transmit the stored data each time a measurement is taken via the scale 120. If 308 is true, the cellular hotspot module 160 transmits the stored measurements and other parameters via the cellular network to the control module 212 at 312. If 308 is false, control may return to 304 to continue collecting measurements from the scale 120 and the sensors 152 and other parameters.

At 316, the control module 212 receives the measurements and other parameters via the cellular network. The control module 212 stores the received data in the memory 216. At 320, the control module 212 may take one or more actions based on the received measurements. For example, the control module 212 may output one or more alerts, turn on or off the HVAC system, and/or turn on or off humidification or dehumidification as discussed above.

Additionally, the control module 212 may make the stored measurements, statistical data regarding the measurements (e.g., time series, averages, etc.) and other data available to one or more computing devices via the Internet or another suitable network.

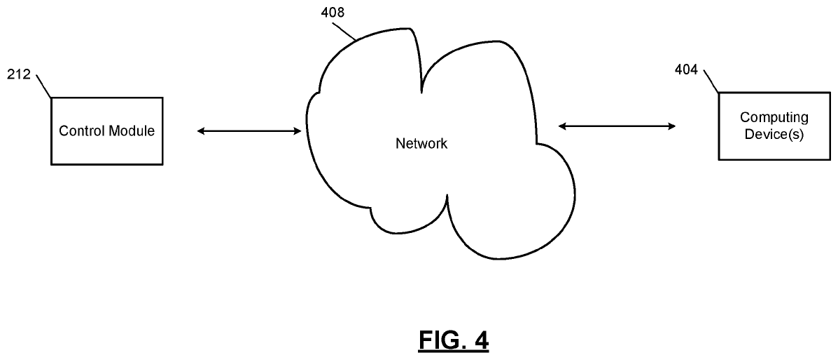

FIG. 4 is a functional block diagram of an example data analysis system. The control module 212 may perform one or more mathematical processes based on the measurements. For example, the control module 212 may generate a time series of the measurements from the scale 120, determine one or more averages of the measurements of the scale 120 over predetermined periods, and/or perform one or more other mathematical operations on the measurements.

The control module 212 may provide the measurements, the other parameters, and the results of the mathematical processing to one or more computing devices 404 via a network 408, such as a local area network (LAN), a wide area network (WAN), or the Internet. Examples of the computing devices 404 include smartphones, tablet devices, laptop computing devices, desktop computing devices, virtual computing devices, and other types of computing devices. The computing device(s) 404 may display the measurements, the other parameters, and/or the results of the mathematical processing on one or more displays. For example, the measurements, the other parameters, and the results of the mathematical processing may be output via a user interface, such as a dashboard.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C #, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A portable weighing system comprising:
a portable table;
a battery disposed on the portable table and that includes an external charge port configured to receive power for charging the battery;
a scale that is disposed on the portable table, that receives power from the battery by wire, and that measures weights of objects, respectively, placed on the scale;
a user interface module disposed on the portable table and configured to receive the measured weights of the objects, respectively, from the scale by wire from the scale; and
a cellular hotspot module disposed on the portable table and configured to:
receive the measured weights of the objects, respectively, wirelessly from the user interface module; and
transmit the measured weights of the objects, respectively, via a cellular network.

2. The portable weighing system of claim 1 further comprising a temperature sensor disposed on the portable table and configured to measure a temperature of air, wherein:
the user interface module is further configured to receive the temperature; and
the cellular hotspot module is further configured to transmit the temperature via the cellular network.

3. The portable weighing system of claim 1 further comprising a humidity sensor disposed on the portable table and configured to measure a humidity of air, wherein:
the user interface module is further configured to receive the humidity; and
the cellular hotspot module is further configured to transmit the humidity via the cellular network.

4. The portable weighing system of claim 1 further comprising a viscosity sensor configured to measure viscosities of the objects, respectively,
wherein:
the user interface module is further configured to receive the viscosities; and
the cellular hotspot module is further configured to transmit the viscosities via the cellular network.

5. The portable weighing system of claim 1 wherein the scale is one of a food grade scale and an industrial grade scale.

6. The portable weighing system of claim 1 wherein the user interface module has an ingress protection (IP) rating for dust and water of the IP66 rating or higher.

7. The portable weighing system of claim 1 wherein the user interface module includes a touchscreen display.

8. The portable weighing system of claim 1 wherein the user interface module includes a Raspberry Pi circuit board.

9. The portable weighing system of claim 1 wherein the user interface module is configured to wirelessly transmit the measured weights of the objects, respectively, to the cellular hotspot module using the message queuing telemetry transport (MQTT) communication protocol.

10. The portable weighing system of claim 1 wherein the portable table includes at least three wheels.

11. A system comprising:
the portable weighing system of claim 1; and
a control module configured to receive the measured weights of the objects, respectively, from the cellular hotspot module via the cellular network.

12. The system of claim 11 wherein the control module is configured to selectively output at least one of a visual alert and an audible alert based on at least one of the measured weights of the objects, respectively.

13. The system of claim 12 wherein the control module is configured to output the at least one of the visual alert and the audible alert when the at least one of the measured weights is one of:
greater than a predetermined weight by at least a predetermined amount; and
less than the predetermined weight by at least the predetermined amount.

14. The system of claim 12 wherein the control module is further configured to output the measured weights of the objects, respectively, to a computing device via a network.

15. The system of claim 14 further comprising the computing device, wherein the computing device is configured to display the measured weights of the objects, respectively, on a display.

16. A portable weighing method comprising:
by a battery disposed on a portable table and including an external charge port configured to receive power for charging the battery, outputting power;
by a scale that is disposed on the portable table, receiving power from the battery by wire, and measuring weights of objects, respectively, placed on the scale;
by a user interface module disposed on the portable table, receiving the measured weights of the objects, respectively, from the scale by wire from the scale; and
by a cellular hotspot module disposed on the portable table:
receiving the measured weights of the objects, respectively, wirelessly from the user interface module; and
transmitting the measured weights of the objects, respectively, via a cellular network.

17. The portable weighing method of claim 16 further comprising:
by a temperature sensor disposed on the portable table, measuring a temperature of air;
by the user interface module, receiving the temperature; and
by the cellular hotspot module, transmitting the temperature via the cellular network.

18. The portable weighing method of claim 16 further comprising:
by a humidity sensor disposed on the portable table, measuring a humidity of air;
by the user interface module, receiving the humidity; and
by the cellular hotspot module, transmitting the humidity via the cellular network.

19. The portable weighing method of claim 16 further comprising:
by a viscosity sensor, measuring viscosities of the objects, respectively;
by the user interface module, receiving the viscosities; and
by the cellular hotspot module, transmitting the viscosities via the cellular network.

20. The portable weighing method of claim 16 wherein the scale is one of a food grade scale and an industrial grade scale.

21. The portable weighing method of claim 16 wherein the user interface module has an ingress protection (IP) rating for dust and water of the IP66 rating or higher.

22. The portable weighing method of claim 16 wherein the user interface module includes a touchscreen display.

23. The portable weighing method of claim 16 wherein the user interface module includes a Raspberry Pi circuit board.

24. The portable weighing method of claim 16 further comprising, by the user interface module, wirelessly transmitting the measured weights of the objects, respectively, to the cellular hotspot module using the message queuing telemetry transport (MQTT) communication protocol.

25. The portable weighing method of claim 16 wherein the portable table includes at least three wheels.

26. The portable weighing method of claim 16 further comprising:
by a control module, receiving the measured weights of the objects, respectively, from the cellular hotspot module via the cellular network.

27. The portable weighing method of claim 26 further comprising, by the control module, selectively outputting at least one of a visual alert and an audible alert based on at least one of the measured weights of the objects, respectively.

28. The portable weighing method of claim 27 further comprising, by the control module, outputting the at least one of the visual alert and the audible alert when the at least one of the measured weights is one of:
greater than a predetermined weight by at least a predetermined amount; and
less than the predetermined weight by at least the predetermined amount.

29. The portable weighing method of claim 27 further comprising, by the control module, outputting the measured weights of the objects, respectively, to a computing device via a network.

30. The portable weighing method of claim 29 further comprising, by the computing device, displaying the measured weights of the objects, respectively, on a display.
